(19) United States
(12) Patent Application Publication
(10) Pub. No.: US 2015/0013167 A1
(43) Pub. Date: Jan. 15, 2015

(54) SHAVER HEAD MECHANISM

(71) Applicant: SHANGHAI POVOS ELECTRIC WORKS CO. LTD., Shanghai (CN)

(72) Inventors: Mingxiong Shen, Shanghai (CN); Wenli Zeng, Shanghai (CN); Yuesheng Deng, Shanghai (CN); Zhiwen Ye, Shanghai (CN)

(73) Assignee: SHANGHAI POVOS ELECTRIC WORKS CO., LTD., Shanghai (CN)

(21) Appl. No.: 14/380,838

(22) PCT Filed: Dec. 3, 2012
(86) PCT No.: PCT/CN2012/001616

§ 371 Date: Aug. 25, 2014

(30) Foreign Application Priority Data
Apr. 10, 2012 (CN) 201210106693.3

(51) Int. Cl. B26B 19/14; B26B 19/38

(52) U.S. Cl. CPC B26B 19/145; B26B 19/14; B26B 19/3853
USPC 30/43.6

(57) ABSTRACT

A shaver includes a shaver head casing, floating cutter holders disposed in the shaver head casing, and two or three circular rotary blade assemblies respectively configured in the central circular holes of the floating cutter holders from below via a rabbet structure; the floating cutter holder is made of a hard rubber material disposed inside and a soft rubber material covering the outside, and is in a fingernail shape, with a circular-arc-shaped outside and an inside opening that is flat or at an angle of 120 degrees; the two or three floating cutter holders are mutually connected via a strip-shaped thin soft rubber layer by means of the opening that is flat or at an angle of 120 degrees, the thickness of the strip-shaped thin soft rubber layer being 0.05-0.15 mm. The floating cutter holder is a soft and flexible integrated structure.

### TECHNICAL FIELD

The present invention relates to the technical field of shaver, specifically to a shaver head mechanism adopting a floating shaver head holder structure.

### BACKGROUND ART

The shaver is an essential daily personal cleaning appliance of men. At present, the floating shaver head holder is always comprised of several pieces of rigid floating shaver head holders distributed in triangular shape, which can carry out pivot rotation relative to the corresponding outer cutter and the supporting frame.

As shown in FIG. 3, FIG. 4 and FIG. 5, the structure of the shaver head mechanism in prior art is as follows: two or three round rotary blade components are separately arranged inside the round hole 1a at the center of the floating shaver head holder 1 in a sealing structure from the underneath of the floating shaver head holder; two or three floating shaver head holders 1 are in split joint with each other through the straight plain end or the included angle of 120 degrees; and one fastener 1b is separately protruded at two sides of each floating shaver head holder 1, so as to be connected to the relevant part of arc-shaped opening in relevant shape of the shaver head housing in a rotating manner; and each floating shaver head holder 1 can raise slightly around the fastener 1b up and down; when it is used to shave, each floating shaver head holder 1 can carry out copying raising while being in touch with face. While using this shaver head mechanism, the pressure to the outer cutter while shaving can be more effectively controlled; however, there are problems as follows:

1. The floating shaver head holders 1 are split type, and the two or three floating shaver head holders 1 are in butt joint with each other through the straight plain end or the included angle of 120 degrees; if flexible material is used to make the floating shaver head holders, the multiple floating shaver head holders 1 will possibly be apart from each other while raising in touch with the face, therefore, when the floating shaver head holders 1 in touch with the face are made of hard Acrylonitrile Butadiene Styrene (ABS) or other materials, it would hurt the face skin;

2. The floating shaver head holders 1 of prior art adopt hard rubber for butt joint, and the floating members would clamp beard and hurt the skin, and will influence normal working of the floating shaver head holders;

3. In prior art, when the multiple floating shaver head holders 1 are placed in touch with the face for copying raising, there would be gaps among the floating shaver head holders 1, and the shaved beard will be clamped between the floating shaver head holders 1. At the same time, the split type floating shaver head holders 1 are not easy to be cleaned; the floating shaver head holders 1 need to be disassembled to clean, especially it is not convenient for the elder users;

4. In the prior art, the floating shaver head holders 1 are processed integrally, which has high requirement and cost.

### SUMMARY OF THE INVENTION

The technical problem to be solved in the present invention is to provide a shaver head mechanism, which can keep the floating shaver head holders in close flexible touch with the face skin while shaving, so as to adjust and control the contact pressure better, and improve the safety and comfort level for shaving.

In order to solve the above problems, the present invention claims a shaver head mechanism that comprises a shaver head housing and a floating shaver head holder arranged in the shaver head housing; two or three round rotary blade components are separately arranged inside the round hole at the center of the floating shaver head holder in a sealing structure from the underneath of the floating shaver head holder; wherein the said floating shaver head holder is made of hard rubber material with soft rubber material covered outside in the shape of nail, and outer side of the floating shaver head holder is arc-shaped and inner side thereof is a straight plain end or an included angle of 120 degrees; two or three said floating shaver head holders are connected together with each other through the straight plain end or the included angle of 120 degrees by a strip-shaped thin soft rubber layer, and the thickness of the strip-shaped thin soft rubber layer is 0.05-0.15 mm; an I-shaped or Y-shaped groove is formed between the two or three said floating shaver head holders and the strip-shaped thin soft rubber layer; and two sides of each floating shaver head holder are separately provided with a slot, so as to be connected with relevant part of relevant fasteners in different shapes in the shaver head housing in a rotating manner; and each floating shaver head holder can raise slightly around the fastener up and down; when it is used to shave, each floating shaver head holder can carry out copying raising while being in touch with face.

Further, the soft rubber material covered outside of the said floating shaver head holder and the strip-shaped thin soft rubber layer are both made of rubber material, and the soft rubber material covered outside of the two neighbored floating shaver head holders and the connected strip-shaped thin soft rubber layer are made by one-step injection molding.

Further, the soft rubber material covered outside of the said floating shaver head holder and the strip-shaped thin soft rubber layer are both made of Thermoplastic Polyurethane Elastomer (TPE) material, and the soft rubber material covered outside of the two neighbored floating shaver head holders and the connected strip-shaped thin soft rubber layer are made by one-step injection molding.

Further, the said strip-shaped thin soft rubber layer is made of Polypropylene (PP) material.

Further, the said rotary blade components include a stationary blade and a movable blade that rotates relevant to the stationary blade in close touch with face, and there is at least one hair inlet on the stationary blade.

Compared to the prior art, the advantages of the present invention are as follows:

1. The floating shaver head holders are a flexible integral structure; when the floating shaver head holders are in touch with the face, the elasticity of the material can distribute the contact pressure from the skin uniformly to each member of the floating shaver head holders, thus to improve comfort level of shaving;

2. There is no groove on the front side of the floating shaver head holders, when the floating shaver head holders are pressed down by the pressure from the skin, it would not clamp the beard, thus to eliminate the safety hazard of the prior art;

3. Because there is no groove on the front side of any floating shaver head holder, it is very easy to clean and can avoid health hazard caused by the problem that the slots in the prior art are not easy to clean; when it is necessary, the floating shaver head holders can be disassembled to clean, which saves time and effort, especially facilitates the elder users;

4. The integral floating shaver head holder is simple in structure, convenient in installation, easy to process, low in assembling requirement and cost.

### BRIEF DESCRIPTION OF THE DRAWINGS

FIG. 1 is the structure diagram of the floating shaver head holders.

FIG. 2 is the structure diagram of the floating shaver head holders after being assembled on the shaver head housing.

FIG. 3 is the structure diagram of the floating shaver head holders in prior art.

FIG. 4 is the structure diagram of the floating shaver head holders of double head in prior art.

FIG. 5 is the structure diagram of the floating shaver head holders of triple head in prior art.

In the Figures: 1. floating shaver head holder; 1a. round hole; 1b. fastener; 2. slot; 3. strip-shaped thin soft rubber layer; 4. rotary blade component; 5. shaver head housing.

### DETAILED DESCRIPTION OF THE PREFERRED EMBODIMENTS

The following is the detailed specification of the present invention in combination with the figures:

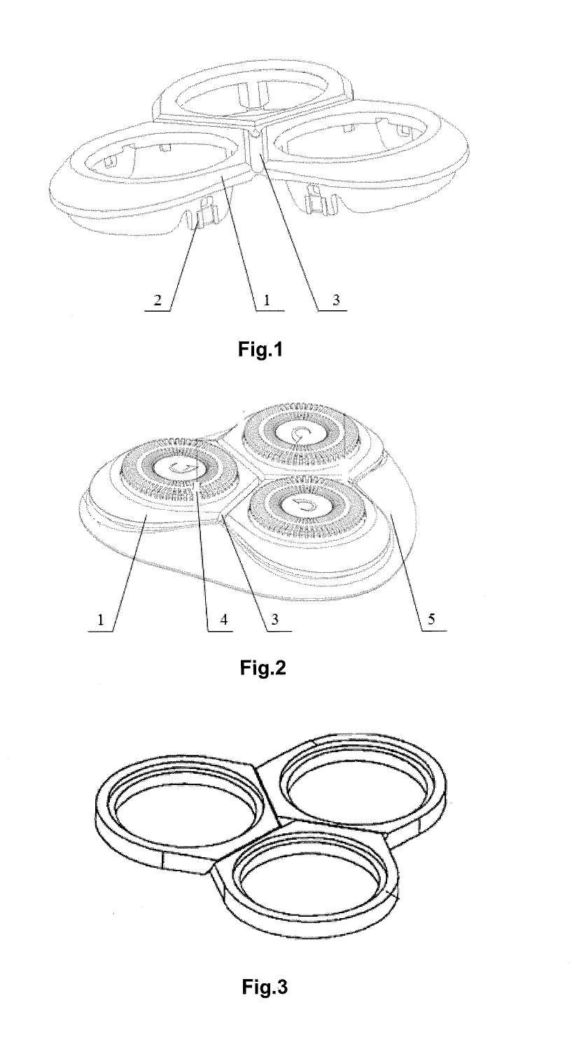

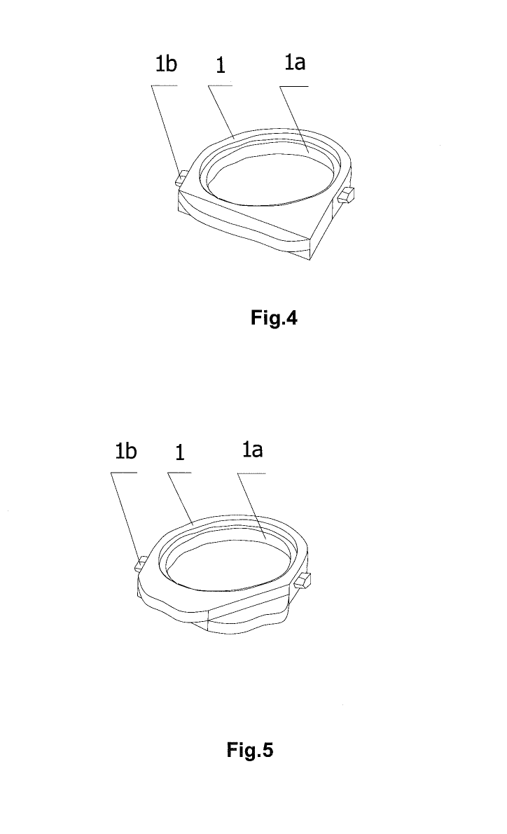

As shown in FIG. 1 and FIG. 2, the present invention claims a shaver head mechanism, which comprises a shaver head housing 5 and a floating shaver head holder 1 arranged in the shaver head housing 5; two or three round rotary blade components 4 are separately arranged inside the round hole 1a at the center of the floating shaver head holder 1 in a sealing structure from the underneath of the floating shaver head holder; the said floating shaver head holder 1 is made of hard rubber material with soft rubber material covered outside in the shape of nail, and outer side of the floating shaver head holder is arc-shaped and inner side thereof is a straight plain end or an included angle of 120 degrees; two or three said floating shaver head holders 1 are connected together with each other through the straight plain end or the included angle of 120 degrees by a strip-shaped thin soft rubber layer 3, and the thickness of the strip-shaped thin soft rubber layer 3 is 0.05-0.15 mm; an I-shaped or Y-shaped groove is formed between the two or three said floating shaver head holders 1 and the strip-shaped thin soft rubber layer 3; and two sides of each floating shaver head holder 1 are separately provided with a slot 2, so as to be connected with relevant part of relevant fasteners in different shapes in the shaver head housing 5 in a rotating manner; and each floating shaver head holder 1 can raise slightly around the fastener up and down; when it is used to shave, each floating shaver head holder 1 can carry out copying raising while being in touch with face.

The soft rubber material covered outside of the said floating shaver head holder 1 and the strip-shaped thin soft rubber layer 3 are both made of rubber material, and the soft rubber material covered outside of the two neighbored floating shaver head holders 1 and the connected strip-shaped thin soft rubber layer 3 are made by one-step injection molding.

The soft rubber material covered outside of the said floating shaver head holder 1 and the strip-shaped thin soft rubber layer 3 are both made of Thermoplastic Polyurethane Elastomer (TPE) material, and the soft rubber material covered outside of the two neighbored floating shaver head holders 1 and the connected strip-shaped thin soft rubber layer 3 are made by one-step injection molding.

The said strip-shaped thin soft rubber layer 3 is made of Polypropylene (PP) material.

The said rotary blade components 4 include a stationary blade and a movable blade that rotates relevant to the said stationary blade in close touch with face, and there is at least one hair inlet on the stationary blade.

The above is the description of the basic principle and main features and advantages. The technical personnel of this industry should understand that the present invention shall not be limited by the above embodiment, and the description in the above embodiments and specification is only for explanation of the principle. Within the principle and scope of the present invention, it can be developed into various modifications and improvements, which shall all fall into the protection scope of the present invention.

The present invention requires the scope of protection defined by the appended claims and their equivalents.

1. A shaver head mechanism, comprising a shaver head housing and a floating shaver head holder arranged in the shaver head housing; two or three round rotary blade components are separately arranged inside the round hole at the center of the floating shaver head holder in a sealing structure from the underneath of the floating shaver head holder; wherein the said floating shaver head holder is made of hard rubber material with soft rubber material covered outside in the shape of nail, and outer side of the floating shaver head holder is arc-shaped and inner side thereof is a straight plain end or an included angle of 120 degrees; two or three said floating shaver head holders are connected together with each other through the straight plain end or the included angle of 120 degrees by a strip-shaped thin soft rubber layer, and the thickness of the strip-shaped thin soft rubber layer is 0.05-0.15 mm; an I-shaped or Y-shaped groove is formed between the two or three said floating shaver head holders and the strip-shaped thin soft rubber layer; and two sides of each floating shaver head holder are separately provided with a slot, so as to be connected with relevant part of relevant fasteners in different shapes in the shaver head housing in a rotating manner; and each floating shaver head holder can raise slightly around the fastener up and down; when it is used to shave, each floating shaver head holder can carry out copying raising while being in touch with face.

2. The shaver head mechanism according to claim 1, wherein the soft rubber material covered outside of the said floating shaver head holder and the strip-shaped thin soft rubber layer are both made of rubber material, and the soft rubber material covered outside of the two neighbored floating shaver head holders and the connected strip-shaped thin soft rubber layer are made by one-step injection molding.

3. The shaver head mechanism according to claim 1, wherein the soft rubber material covered outside of the said floating shaver head holder and the strip-shaped thin soft rubber layer are both made of Thermoplastic Polyurethane Elastomer (TPE) material, and the soft rubber material covered outside of the two neighbored floating shaver head holders and the connected strip-shaped thin soft rubber layer are made by one-step injection molding.

4. The shaver head mechanism according to claim 1, wherein the said strip-shaped thin soft rubber layer is made of Polypropylene (PP) material.

5. The shaver head mechanism according to claim 1, wherein the said rotary blade components include a stationary blade and a movable blade that rotates relevant to the stationary blade in close touch with face, and there is at least one hair inlet on the stationary blade.

6. The shaver head mechanism according to claim 2, wherein the said rotary blade components include a stationary blade and a movable blade that rotates relevant to the stationary blade in close touch with face, and there is at least one hair inlet on the stationary blade.

7. The shaver head mechanism according to claim 3, wherein the said rotary blade components include a stationary blade and a movable blade that rotates relevant to the stationary blade in close touch with face, and there is at least one hair inlet on the stationary blade.

8. The shaver head mechanism according to claim 4, wherein the said rotary blade components include a stationary blade and a movable blade that rotates relevant to the stationary blade in close touch with face, and there is at least one hair inlet on the stationary blade.
